(19) United States
(12) Patent Application Publication
(10) Pub. No.: US 2025/0336091 A1
(43) Pub. Date: Oct. 30, 2025

(54) METHODS AND SYSTEMS FOR NON-EARTH IMAGING OF A NON-EARTH OBJECT

(71) Applicant: Maxar Intelligence Inc., Westminster, CO (US)

(72) Inventors: Christina Selby, Westminster, CO (US); Christian Ketelsen, Westminster, CO (US)

(21) Appl. No.: 18/650,482

(22) Filed: Apr. 30, 2024

(51) Int. Cl. G06T 7/73; G06T 7/11; G06T 7/80

(52) U.S. Cl. CPC G06T 7/75; G06T 7/11; G06T 7/80; G06T 2207/10032

(57) ABSTRACT

Examples of the present disclosure include a method for approximating a non-earth imaging camera model for a non-earth sensor includes obtaining a physical camera model, receiving a target range value, determining a plurality of space-based coordinates of a plurality of points about a line of sight of the sensor in proximity to a distance corresponding to the received target range value, for each of the plurality of locations, determining line and sample coordinates on an image thereof via the physical camera model based on the space-based coordinates of the plurality of points, and based on the determined line and sample coordinates for each of the plurality of points, fitting an approximate camera model thereto.

### BACKGROUND

Examples of the disclosure relate to non-earth imaging (NEI). In particular, examples of the disclosure relate to an approximate camera model based on a physical camera model.

### SUMMARY

In one aspect of the present disclosure, a method for approximating a non-earth imaging camera model for a non-earth sensor includes obtaining a physical camera model, receiving a target range value, determining a plurality of space-based coordinates of a plurality of points about a line of sight of the sensor in proximity to a distance corresponding to the received target range value, for each of the plurality of locations, determining line and sample coordinates on an image thereof via the physical camera model based on the space-based coordinates of the plurality of points, and based on the determined line and sample coordinates for each of the plurality of points, fitting an approximate camera model thereto.

In an example of the above aspect, the sensor includes an image capture device. In another example, receiving the physical camera model includes receiving a physics-based camera model that includes a plurality of sensor-based parameters. In yet another example, the plurality of sensor-based parameters include at least one of sensor ephemeris data, sensor attitude, distortion model of sensor optics, and a model of a focal plane geometry of the sensor. In a further example, receiving the target range value includes one of receiving a distance at which a target is located along a line of sight of the sensor, and determining a distance of a portion of space along a line of sight of the sensor. In other examples, determining the plurality of space-based coordinates of the plurality of points includes determining the plurality of space-based coordinates thereof inside a volume enveloping an intersection of the line of sight of the sensor and an end of the target range value opposite the image capture device. For example, the volume is within a range of about 25 meters to about 100 meters of an ephemeris data of the target. As discussed herein, ephemeris data includes both the position of an object as well as the velocity vector thereof.

In another example, fitting the approximate camera model to the plurality of points and their corresponding line and sample coordinates includes determining one or more parameters of the approximate camera model. In a further example, the one or more parameters include at least one of a camera factor matrix determined based on modeled sensor location, a rotation matrix that maps earth-centered coordinates to sensor coordinates, and an internal calibration matrix.

Other aspects of the disclosure include a method of estimating space-based coordinates of a target based on an image thereof, the method including obtaining the image of the target in space, the image including line and sample coordinates of the target thereon, and based on an application of the approximate camera model to the line and sample coordinates of the target in the image, obtaining corresponding three-dimensional coordinates of the target in space. Yet other aspects include a method of estimating line and sample coordinates of a target on an image based on space-based coordinates thereof, the method including obtaining space-based coordinates of the target in space, and based on an application of the approximate camera model to the space-based coordinates of the target, obtaining corresponding line and sample coordinates of the target in the image thereof. In a further example, obtaining the space based coordinates includes obtaining ephemeris data of the target.

The details of one or more techniques are set forth in the accompanying drawings and the description below. Other features, objects, and advantages of these techniques is apparent from the description, drawings, and claims.

### BRIEF DESCRIPTION OF THE DRAWINGS

FIG. 1 is a schematic diagram illustrating an image capture system for a non-earth object.

FIG. 2 is a schematic illustration of push broom imaging.

FIGS. 3A and 3B are illustrations of a plurality of captured images of the non-earth object, in accordance with various examples of the disclosure.

FIG. 4 is an illustration of an approximate camera model fitting, according to various examples of the disclosure.

FIG. 5 is a flowchart illustrating a method of generating an approximate camera model, in accordance with various examples of the disclosure.

FIGS. 6A and 6B are illustrations of a comparative approximation of the location of the non-earth object, in accordance with various examples of the present disclosure.

Before one or more examples of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the terminology used herein is for the purpose of description and should not be regarded as limiting.

### DETAILED DESCRIPTION

### Selected Definitions

For the purposes of interpreting this specification, the following definitions will apply and whenever appropriate, terms used in the singular will also include the plural and vice versa. The definitions set forth below shall supersede any conflicting definitions in any documents incorporated herein by reference.

As used herein, the singular forms “a,” “an,” and “the,” include both singular and plural referents unless the context clearly dictates otherwise.

The terms “comprising,” “comprises,” and “comprised of” as used herein are synonymous with “including,” “includes,” or “containing,” “contains,” and are inclusive or open-ended and do not exclude additional, non-recited members, elements or method steps. It is appreciated that the terms “comprising,” “comprises,” and “comprised of” as used herein comprise the terms “consisting of,” “consists,” and “consists of.”

The recitation of numerical ranges by endpoints includes all numbers and fractions subsumed within the respective ranges, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6, or ≥7, etc. of said members, and up to all said members.

Unless otherwise defined, all terms used in the present disclosure, including technical and scientific terms, have the meaning as commonly understood by one of ordinary skill in the art to which this disclosure belongs. By means of further guidance, term definitions are included to better appreciate the teaching of the present disclosure. In the following passages, different aspects of the present disclosure are defined in more detail. Each aspect so defined may be combined with any other aspect or aspects unless clearly indicated to the contrary.

Reference throughout this specification to “one example” or “an example” means that a particular feature, structure or characteristic described in connection with the example is included in at least one example of the present disclosure. Thus, appearances of the phrases “in one example” or “in an example” in various places throughout this specification are not necessarily all referring to the same example, but may. Furthermore, the particular features, structures or characteristics may be combined in any suitable manner, as would be apparent to a person skilled in the art from this disclosure, in one or more examples. Furthermore, while some examples described herein include some, but not other features included in other examples, combinations of features of different examples are meant to be within the scope of the disclosure, and form different examples, as would be understood by those in the art. For example, in the appended claims, any of the claimed examples can be used in any combination.

When the terms “about” or “substantially” are used in this specification in connection with a numerical value, it is intended that the associated numerical value include a tolerance of ±10% around the stated numerical value.

Reference is made herein of earth-centered inertial (ECI) coordinates, which are typically know as global positioning system (GPS) coordinates. Pixel coordinates as discussed herein correspond to line and sample, or x and y, coordinates of an object as displayed on a two-dimensional image.

In the present disclosure, reference is made to the accompanying drawings that form a part hereof, and in which are shown by way of illustration only of specific examples in which the present disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims.

### Non-Earth Imaging (NEI) Camera Model

Non-earth imaging (NEI), also referred to as satellite-to-satellite imaging, is the imaging of a non-earth object such as, e.g., a satellite, an active or inactive aircraft, a rocket body, space debris, or other object, from an image capture device that is also in space such as, e.g., an image capturing satellite. The non-earth object may be referred to herein as a target. For example, NEI is achieved by using spaced-based sensors located at the image capture device to capture high-resolution images of the target. In other words, NEI includes the use of a space-based imaging system that is typically used for earth imaging to image an object in space.

A camera model describes the mathematical relationship between the three-dimensional (3D) coordinates of a point in space and the two-dimensional (2D) coordinates of an image thereof, or a projection thereof, on an image plane. Obtaining the actual location of an object in space is typically achieved via the use of a physical camera model, also referred to as physics-based, or sensor-based, camera model. In various examples of this disclosure, an approximate camera model may be developed to approximate the physical camera model in describing the mathematical relationship between the target position and the line and sample coordinates of the projection of the target in an image of the target. The target position may be represented in earth-centered-inertial (ECI) coordinates, also referred to herein as space-based coordinates.

According to various examples of the current disclosure, the approximate NEI camera model may be useful for the analysis of an NEI image of the target in space with an accuracy approaching a physical camera model. The approximate camera model may first rely on an approximation or estimation of the distance of the target in space from the sensor or image capture device, and then estimate the location of the target in space with respect to earth-centered-inertial (ECI) coordinates based on the estimated distance of the target. Accordingly, examples of the disclosure include a finite projective camera model approximation of the physical camera model that is sufficiently accurate for earth-centered-inertial (ECI) coordinates near the target in space in an NEI image. The approximate camera model may be used in applications including 3D NEI target reconstruction and trajectory and range estimation of various objects or targets in space and the distance separating the objects in space from the image capture device.

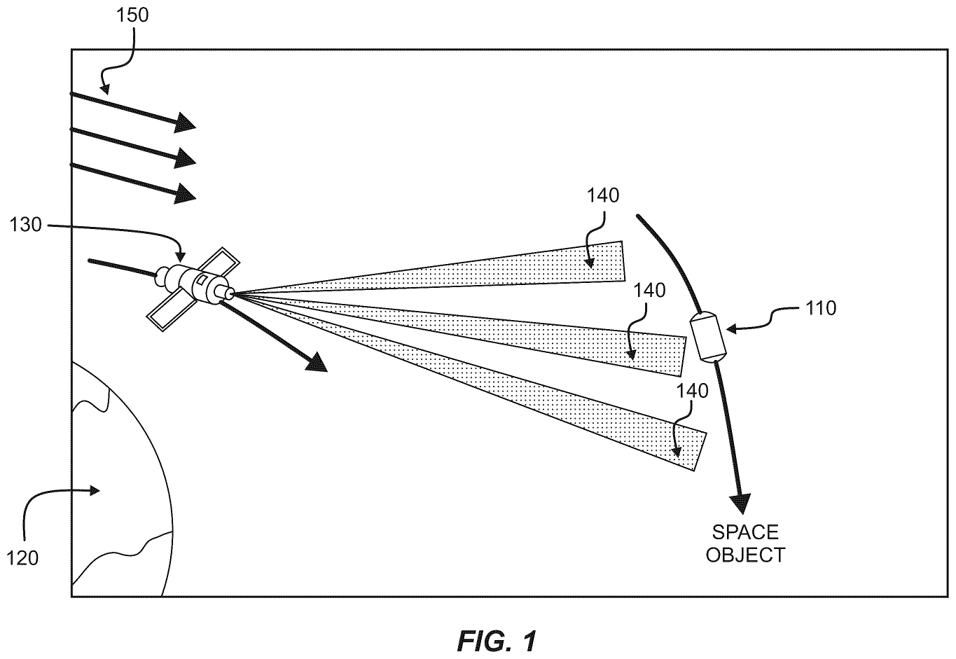

FIG. 1 is a schematic diagram illustrating an image capture system for a non-earth object. In FIG. 1, an object, or target, in space 110 is illustrated as orbiting around the earth 120. In examples, a sensor 130 such as, e.g., an image capture device or an imaging satellite, is positioned in space to capture one or more images or videos of the non-earth object 110. In operation and according to various examples, the image capture device 130 may capture images of the non-earth object 110 via push broom imaging, as illustrated in the successive lines 140 of image capture. As discussed above, examples of the disclosure provide a method of determining the ECI coordinates of the non-earth object, or target, 110 based on an estimate of the range or distance between the object 110 and the sensor 130 and on an image of the object 110 captured by the sensor 130. For example, line and sample coordinates of the object 110 on the image formed by the sensor 130 may be used to calculate, together with the range or distance discussed above, the 3D ECI coordinates of the non-earth object 110.

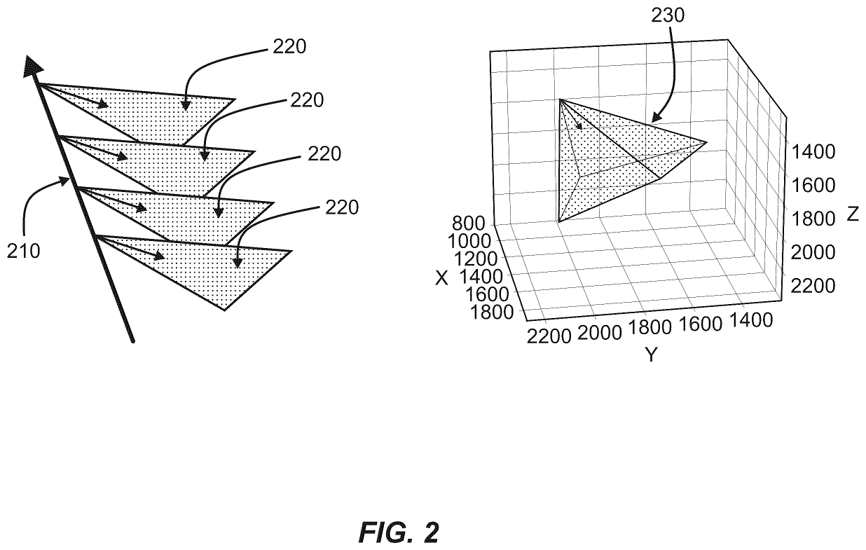

FIG. 2 is a schematic illustration of push broom imaging. In FIG. 2, as an image sensor such as, e.g., the sensor 130 illustrated in FIG. 1, travels along the direction 210, a plurality of image capture events, or scans, 220, are performed by the image capture device to capture an image of the target or object 230. Push broom imaging devices, such as the sensor 130 of FIG. 1, also referred to herein as push broom scanners, typically use a line of detectors arranged perpendicularly to the flight direction 210 of the sensor. As the sensor travels forward along direction 210, the image is collected one line or scan 220 at a time, with all of the pixels in a given line 220 being measured simultaneously or contemporaneously. Accordingly, each line 220, being taken at a slightly different time, is combined together to form a two-dimensional image of the object 230 being imaged.

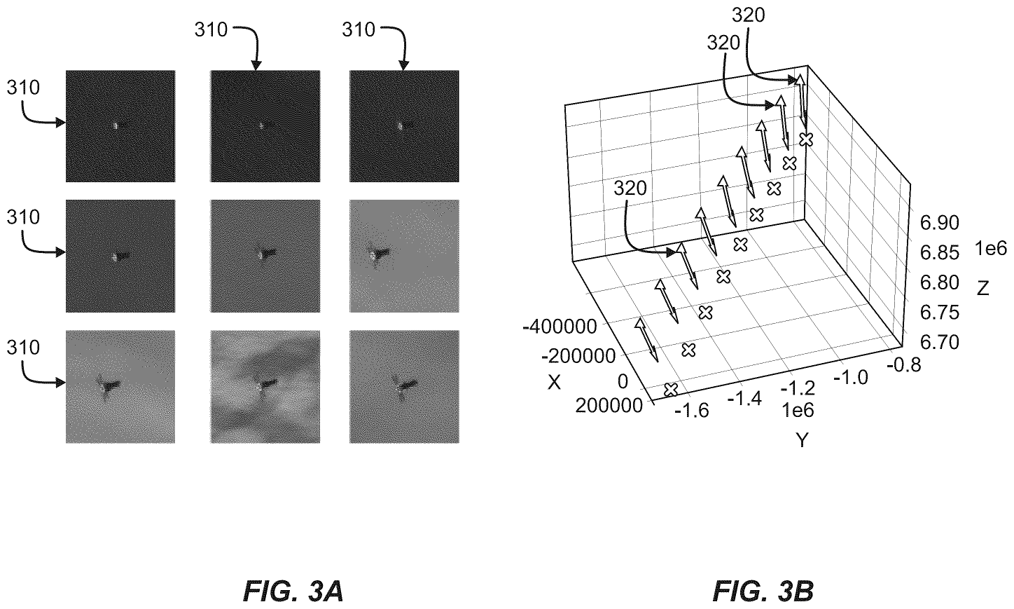

FIGS. 3A and 3B are illustrations of a plurality of captured images of the non-earth object, in accordance with various examples of the disclosure. FIG. 3A illustrates a captured image corresponding to each one of the positions illustrated in FIG. 3B. For example, each image 310 illustrated in FIG. 3A corresponds to one scan 320 illustrated in FIG. 3B.

In FIG. 3B, the NEI target location as calculated with the NEI approximate camera model and model range is denoted with an “x” 330. The physical sensor location, obtained via the physical camera model, and the pointing vector associated with the target centroid location for each target location is shown with the arrow adjacent the “x” for each scan 320.

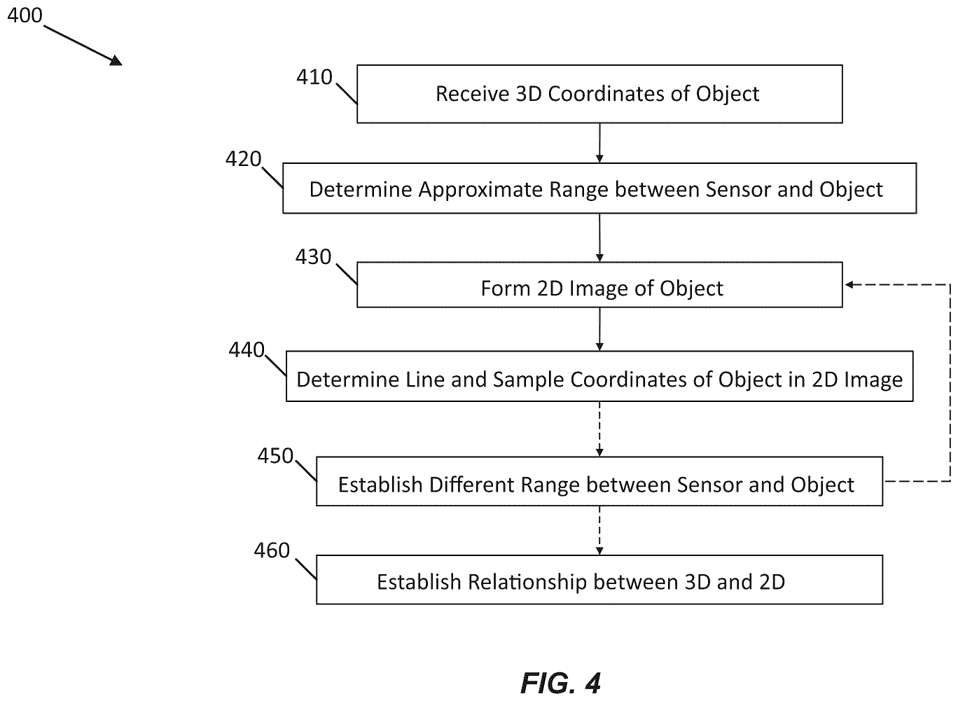

FIG. 4 is an illustration of an approximate camera model fitting, according to various examples of the disclosure. In FIG. 4, a target range value 440 is established, the target range value 440 separating a sensor 430, also referred to herein as image capture device, from, e.g., a target 410 along the line of sight of the sensor 430. In other examples, the target range value 440 may be obtained by estimating the ephemeris data of the sensor 430 and of the target 410. The expression “ephemeris data” as used herein refers to include space-based coordinates as well as the velocity vector of an object, in this case of the target or the sensor 430. For example, the ephemeris data may be understood to include global positioning system (GPS) data of the target or of the sensor 430.

In other examples, the target range value 440 may be a distance at which an image of non-earth space is to be imaged, even when no target is present or identified. In this case, there may not be an identified target such as target 410 at the end of the target range value 440, and any image formed may be an image of that portion of space along with any objects present therein.

In various examples, in order to generate the approximate camera model, a plurality of points 420, which may not correspond to any existing structure and are determined for purposes of generating the camera model, are determined around the location of the desired target location 410. In an example, the plurality of points 420 are located at an end distance of the target range value 440 from the sensor 430 along the line of the sight of the sensor 430. When a desired target location 410 is present as illustrated in FIG. 4, the plurality of points 420 are located around an intersection of the target range value 440 and the location data of the desired target location 440 obtained via the physical camera model. For example, the space-based 3D or ECI coordinates of each of the points 420 may be determined and used in Equations (1)-(3) below to fit an approximate camera model. In various examples, the points 420 may be located in proximity to the desired target location 410 within a volume 450. The volume 450 may extend to, e.g., about 100 meters in any direction around the target 410. In other examples, the volume 450 may extend to about 50 meters, or to about 20 meters, in any direction around the target 410. Accordingly, when the plurality points 420 are determined within the volume 450, the approximate camera model is fitted thereto. As described herein, the volume 450 is located about an end distance of the target range value 440 along the line of the sight of the sensor 430. When a target 410 is present as illustrated in FIG. 4, the volume 450 is located around an intersection of the received target range value 440 and the location data of the target 410 as determined by the physical camera model.

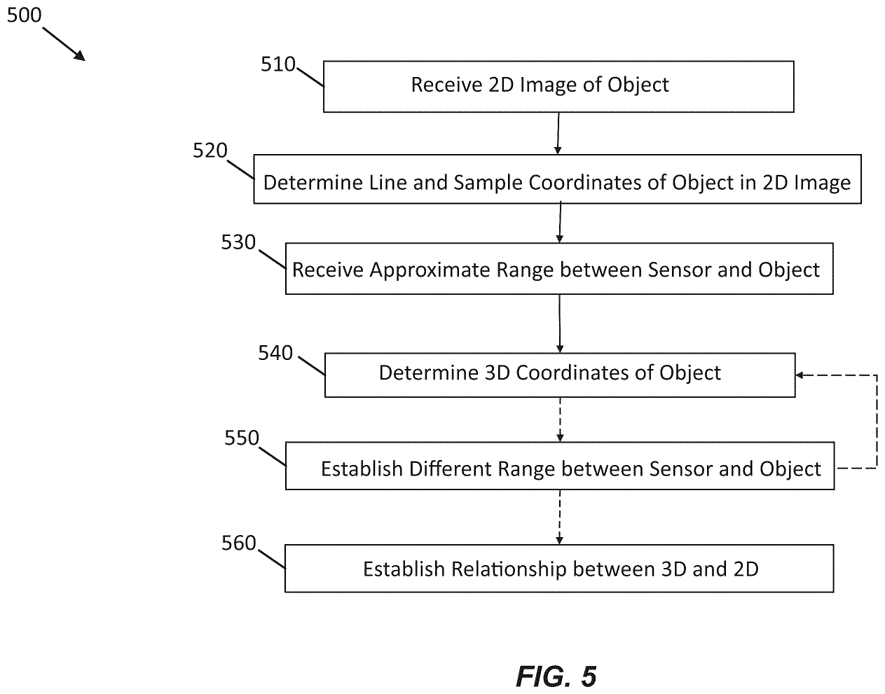

FIG. 5 is a flowchart illustrating a method of generating an approximate camera model, in accordance with various examples of the disclosure. In FIG. 5, the method 500 includes operation 510, during which a physical camera model is obtained. For example, operation 510 includes obtaining the physical camera model by obtaining a plurality of sensor-based parameters, the sensor being, e.g., an imaging satellite or non-earth image capture device. In examples, the sensor-based parameters may include, e.g., sensor specific data such as, e.g., sensor optics, sensor ephemeris data (e.g., velocity and location) during forming of the image of the target, sensor attitude during forming of the image of the target, the model of the focal plane geometry of the sensor, and a distortion model associated with various lenses of the sensor. In an example, the physical camera model may include the actual location of the sensor

During operation 520, the method 500 includes receiving a target range value. For example, receiving the target range value can be achieved by receiving an approximate distance at which the target is located along the line of sight of the image capture device or sensor. In an example, the target range value is determined via the ephemeris data of the target and of the sensor. In other examples, the target range value is a distance determined independently of the presence of a known target, and when no target is identified, the target range value is a distance at which a non-earth image is desired to be acquired.

During operation 530, the method 500 includes determining a plurality of space-based coordinates for a plurality of points about a line of sight of the sensor. For example, the plurality of points may be in proximity to an end distance of the target range value. For example, operation 530 includes determining the plurality of space-based coordinates of the plurality of points inside a volume enveloping an intersection of the line of sight of the sensor at the end of the target range value and the actual location of the target determined by the physical camera model. With reference to FIG. 4, operation 530 includes determining the locations of points 420 within the volume 450.

During operation 540, for the coordinates of each point determined during operation 530, line and sample coordinates of the point in an image formed by the sensor are determined. The line and sample coordinates may be understood more commonly as the (x,y) coordinates of each point on the image formed by the sensor. Accordingly, a relationship may be established by the camera model between the space-based coordinates of the plurality of points and their corresponding line and sample coordinates.

During operation 550, the approximate camera model is fitted to the data of the plurality of points determined during operation 530. For example, the approximate camera model may be fitted to the correspondence between the space-based coordinates of each point determined during operation 530 and their corresponding line and sample coordinates determined during operation 540. For example, the approximate camera model may be represented by the matrix P discussed in Equation (1) discussed below. Fitting the approximate camera model to the above-discussed data may be performed using a fitting technique such as, e.g., the Direct Linear Transformation (en.wikipedia.org/wiki/Direct_linear_transformation) so as to satisfy Equation (1), or Equations (1)-(3) below. For example, Equation (1) below may be applied to the space-based coordinates of each of the points determined during operation 530, and the line and sample coordinates of each one of these points:

$$P [ \begin{matrix}x \\ y \\ z \\ 1\end{matrix} ] = w [ \begin{matrix}line \\ sample \\ 1\end{matrix} ] \qquad ( 1 )$$

In Equation (1), x, y, and z are the ECI coordinates, also referred as space-based coordinates, of an object in space. The sensor is also referred to herein as image capture device or satellite. The “line” and “sample” are the two-dimensional (2D) coordinates of each point as imaged by the sensor. P is the camera factor, e.g., the approximate camera model, that can be determined by equation (2):

$$P = KR [ \begin{matrix}I & - C\end{matrix} ] \qquad ( 2 )$$

In Equation (2), C is the modeled sensor location in 3D ECI coordinates, I is a 3×3 identity matrix, R is the rotation matrix that maps ECI coordinates to the coordinates of the sensor. The internal camera calibration matrix K can be calculated based on Equation (3) below:

$$K = [ \begin{matrix}{α}_{x} & s & {x}_{0} \\ 0 & {α}_{y} & {y}_{0} \\ 0 & 0 & 1\end{matrix} ] \qquad ( 3 )$$

In Equation (3), αₓ and α_{y} are scale factors in the x-coordinate and y-coordinate directions, respectively; s is the skew, and (x₀, y₀) are the coordinates of the target as formed in the image. Accordingly, during operation 550, the above parameters are approximated through a mathematical fitting process on the basis of the space-based coordinates of the plurality of points around the target and the resulting line and sample coordinates of each point in the image thereof.

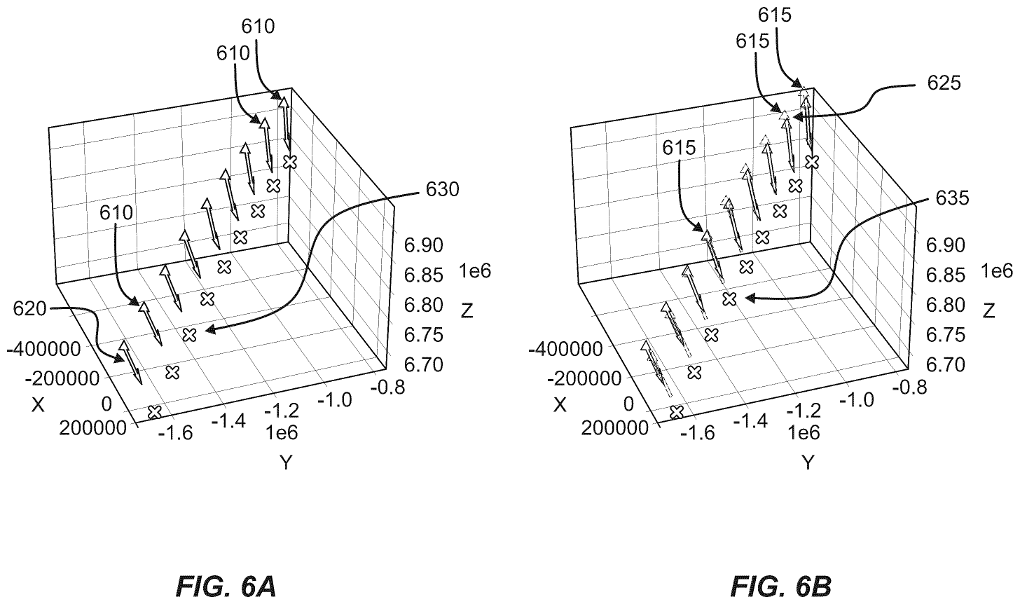

FIGS. 6A and 6B are illustrations of a comparative approximation of the location of the sensor in space, in accordance with various examples of the present disclosure. FIG. 6A illustrates the estimated location of the target in space 630 obtained, e.g., via known target ephemeris, and 610 indicates the actual location of the sensor, as obtained via the physical camera model. The arrow 620 between the estimated location 630 of the target in space and the actual location of the sensor 610 indicates the line of sight of the sensor when imaging the target.

FIG. 6B illustrates the approximate location 615 of the sensor, as determined by the approximate camera model of examples of the present disclosure, overlapped with the actual location 610 of the sensor, obtained by the physical camera model. Accordingly, FIGS. 6A and 6B illustrate the difference between the actual physical sensor location 610 obtained by the physical camera model, and the approximate sensor location 615 as determined via the approximate camera model. FIG. 6B clearly shows a substantial overlap between the approximated and the actual locations of the sensor. Such substantial overlap indicates a high degree of correlation and accuracy of the methods discussed herein.

Although various examples and examples are described herein, those of ordinary skill in the art will understand that many modifications may be made thereto within the scope of the present disclosure. Accordingly, it is not intended that the scope of the disclosure in any way be limited by the examples provided.

What is claimed is:

1. A method of approximating a non-earth imaging (NEI) camera model for a non-earth sensor, the method comprising:
obtaining a physical camera model;
receiving a target range value;
determining a plurality of space-based coordinates of a plurality of points about a line of sight of the sensor in proximity to a distance corresponding to the received target range value;
for each of the plurality of locations, determining line and sample coordinates on an image thereof via the physical camera model based on the space-based coordinates of the plurality of points; and
based on the determined line and sample coordinates for each of the plurality of points, fitting an approximate camera model thereto.

2. The method of claim 1, wherein the sensor comprises an image capture device.

3. The method of claim 1, wherein receiving the physical camera model comprises receiving a physics-based camera model that comprises a plurality of sensor-based parameters.

4. The method of claim 3, wherein the plurality of sensor-based parameters comprise at least one of:
sensor ephemeris data;
sensor attitude;
distortion model of sensor optics; and
a model of a focal plane geometry of the sensor.

5. The method of claim 1, wherein receiving the target range value comprises one of:
receiving a distance at which a target is located along a line of sight of the sensor; and
determining a distance of a portion of space along a line of sight of the sensor.

6. The method of claim 1, wherein determining the plurality of space-based coordinates of the plurality of points comprises determining the plurality of space-based coordinates thereof inside a volume enveloping an intersection of the line of sight of the sensor and an end of the target range value opposite the image capture device.

7. The method of claim 6, wherein the volume is within a range of about 25 meters to about 100 meters of an ephemeris data of the target.

8. The method of claim 1, wherein fitting the approximate camera model to the plurality of points and their corresponding line and sample coordinates comprises determining one or more parameters of the approximate camera model.

9. The method of claim 7, wherein the one or more parameters comprise:
a camera factor matrix determined based on modeled sensor location;
a rotation matrix that maps earth-centered coordinates to sensor coordinates; and
an internal calibration matrix.

10. A method of estimating space-based coordinates of a target based on an image thereof, the method comprising:
obtaining the image of the target in space, the image including line and sample coordinates of the target thereon;
receiving a target range value; and
based on an application of the approximate camera model of claim 1 to the line and sample coordinates of the target in the image and to the target range, obtaining corresponding three-dimensional coordinates of the target in space.

11. A method of estimating line and sample coordinates of a target on an image based on space-based coordinates thereof, the method comprising:
obtaining space-based coordinates of the target in space; and
based on an application of the approximate camera model of claim 1 to the space-based coordinates of the target, obtaining corresponding line and sample coordinates of the target in the image thereof.

12. The method of claim 11, wherein obtaining the space based coordinates of the target comprises obtaining position data of the target.
